(19) United States
(12) Patent Application Publication
(10) Pub. No.: US 2004/0211531 A1
(43) Pub. Date: Oct. 28, 2004

(54) Thermal solar screen and method of assembly thereof

(76) Inventor: Shawn D. Dybdahl, Las Vegas, NV (US)

Correspondence Address: WEISS & MOY PC, 4204 NORTH BROWN AVENUE, SCOTTSDALE, AZ, 85251, US

(21) Appl. No.: 10/423,324

(22) Filed: Apr. 28, 2003

(51) Int. Cl. E06B 3/30

(52) U.S. Cl. 160/377

(57) ABSTRACT

Kits for thermal solar screens each comprise a pre-formed screen-frame assembly, a pair of end members and a plurality of corner inserts, which can be packed into a container for transportation. Alternatively, the kits each comprise a pre-formed screen-frame assembly and a pair of pre-formed end members, which also can be packed into a container for transportation. Thermal solar screens are assembled by connecting a pair of corner inserts to the ends of each end member to form a pair of pre-formed end members. The preformed end members are connected to the pre-formed screen-frame assembly and the screen at open ends of the screen are connected to the pre-formed end members by a spline. Alternatively, thermal solar screens are assembled by connecting a pre-formed screen-frame assembly and a pair of pre-formed end members. The pre-formed end members are connected to the pre-formed screen-frame assembly and the screen at open ends of the screen are connected to the pre-formed end members by a spline.

### FIELD OF THE INVENTION

This invention relates generally to screens and methods for the assembly thereof, and more specifically, to thermal solar screens and methods for the assembly thereof including providing kits thereof.

### BACKGROUND OF THE INVENTION

In the past, various types of thermal solar screens were developed. For example, essentially rectangular shaped frames with screening material inserted into them were used for shading and as insect and dust barriers. Thermal solar screens were generally installed on the outside of windows or any other suitable opening in a building, such as a patio. Assembly of thermal solar screens was difficult for the average consumer and usually left to professionals because they had numerous parts and most consumers did not like to read assembly instruction sheets, which was necessary to assemble prior thermal solar screens.

Current thermal solar screens are a great benefit to buildings because they greatly reduce the amount of heat and glare when installed on the outside of windows, thereby improving energy conservation. Thermal solar screens also provide more privacy inside a building, while allowing full visibility through windows.

Other benefits of thermal solar screens include prevention of fading and dry rot because thermal solar screens prevent the sun's rays from fading and damaging window drapes, carpets, furniture and other perishables. Thermal solar screens do not inhibit natural ventilation and are effective insulating barriers year round.

Professional installers typically have done the entire fairly complex assembly operation to provide thermal solar screens located within suitable frames. Subsequently, the four parts of the frame, the screen and other parts necessary for completing the solar screen were offered piecemeal for consumers willing to make their own thermal solar screens, with variable results, depending on the consumer's assembly skill. Many non-professionals have difficulty with piecemeal construction. For less skilled consumers material wastage and inappropriate joining of materials is common. Furthermore, loss of time because of inexperience and/or failure to follow assembly instructions became an important factor in undertaking the relatively difficult task of assembling a thermal solar screen from a number of separate components thereof.

For the foregoing reasons, there is a need to provide kits and methods of easy fabrication for thermal solar screens.

### SUMMARY OF THE INVENTION

Accordingly, it is an object of this invention to provide a thermal solar screen and method of assembly of the thermal solar screen that can be easily completed by a non-professional.

It is a further object of this invention to provide a thermal solar screen that can be packaged and transported as a kit for ease of use by any consumer.

It is a still further object of this invention to provide a thermal solar screen kit that has pre-assembled portions of a thermal screen to facilitate assembly of the thermal screen for various sized windows.

### PREFERRED EMBODIMENTS OF THE INVENTION

In accordance with one embodiment of this invention, a kit for assembling a thermal solar screen-frame assembly comprises, in combination a pre-formed screen-frame assembly comprising a thermal solar screen and two pre-attached frame members, the thermal solar screen being attached at each one of two opposite ends thereof to one of the two pre-attached frame members; a pair of other frame members; and means for connecting the pre-formed screen-frame assembly to the pair of other frame members to form a four frame sided unitary thermal solar screen-frame assembly. The kit includes a plurality of corner inserts for connecting to ends of the pair of other frame members to the pre-formed screen-frame assembly. The thermal solar screen is connected to each frame member of the four frame sided unitary thermal screen-frame assembly by a spline.

In accordance with a second embodiment of this invention, a kit for assembling a thermal solar screen-frame assembly comprises, in combination a pre-formed screen-frame assembly comprising a thermal solar screen and two pre-attached frame members; and a pair of pre-formed frame members for coupling to the two pre-attached frame members to form a four frame sided unitary thermal solar screen-frame assembly. Each one of the pair of pre-formed frame members comprises a frame member having two ends and a pair of connecting corner inserts, each one of the pair of corner inserts connected to one of the two ends of the frame member. Each one of the pair of connecting corner inserts is also connected to one end of one of the pre-attached frame members to form a four frame sided unitary thermal solar screen-frame assembly. The thermal solar screen is connected to each frame member of the four frame sided unitary thermal screen-frame assembly by a spline.

In accordance with a third embodiment of this invention, a method for assembling a thermal solar screen-frame assembly comprises the steps of providing a pre-formed screen-frame assembly comprising a thermal solar screen and two pre-attached frame members; providing a pair of other frame members; and providing means for connecting the pre-formed screen-frame assembly to the pair of other frame members to form a four frame sided unitary thermal solar screen-frame assembly. The method includes the step of providing a plurality of corner inserts for connecting to ends of the pair of other frame members to the pre-formed screen-frame assembly. The method further comprises the step of connecting the thermal solar screen to each frame member of the four frame sided unitary thermal screen-frame assembly by a spline.

In accordance with a fourth embodiment of this invention, a method for assembling a thermal solar screen-frame assembly comprises the steps of providing a pre-formed screen-frame assembly comprising a thermal solar screen and two pre-attached frame members; and providing a pair of pre-formed frame members for coupling to the two pre-attached frame members to form a four frame sided unitary thermal solar screen-frame assembly. The method includes the step of providing each one of the pair of pre-formed frame members comprises a frame member having two ends and a pair of connecting corner inserts, each one of the pair of corner inserts connected to one of the two ends of the frame member. The method further includes the step of connecting each one of the pair of connecting corner inserts to one end of one of the pre-attached frame members to form a four frame sided unitary thermal solar screen-frame assembly. The method further comprises the step of connecting the thermal solar screen to each frame member of the four frame sided unitary thermal screen-frame assembly by a spline.

The foregoing and other objects, features, and advantages of the invention will be apparent from the following, more detailed description of the preferred embodiments of the invention, as illustrated in the accompanying drawings.

### BRIEF DESCRIPTION OF THE DRAWINGS

FIG. 1 is a perspective front elevation view of a thermal solar screen aligned for fitting onto the outside of a window;

FIG. 2 is a partial perspective view on an enlarged scale of a side corner of the thermal solar screen of FIG. 1;

FIG. 3 is a cross section view on an enlarged scale taken through 3-3 of FIG. 2 showing the thermal solar screen and a screen frame member at one side corner of the thermal solar screen;

FIG. 4 is a partial perspective view on an enlarged scale of an unassembled side corner of the thermal solar screen of FIG. 1;

FIG. 5 is a front elevation view of a partially assembled thermal solar screen of FIG. 1 prior to coupling together a pre-formed screen-frame assembly to a pair of pre-formed frame members to make the assembled thermal solar screen shown in FIG. 1; and

FIG. 6 is a perspective view of a plurality of members of the thermal solar screen of FIG. 5 partially inserted within a container to provide a kit for consumers.

### DESCRIPTION OF THE INVENTION

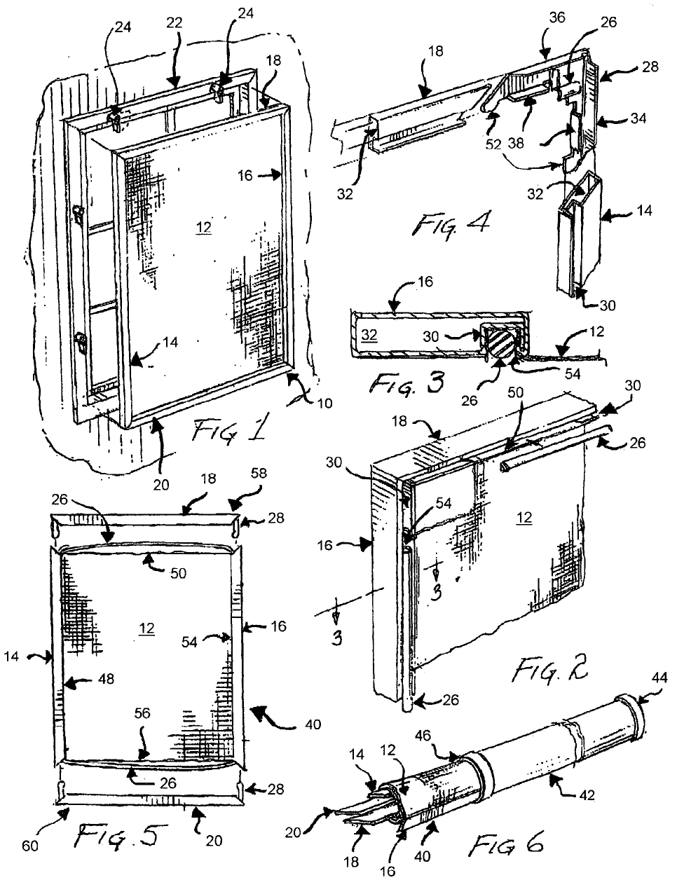

Referring to FIG. 1, a thermal solar screen comprises a four sided unitary thermal solar screen-frame assembly 10 and a thermal solar screen 12 coupled to the four sided unitary thermal solar screen-frame assembly 10. The thermal solar screen is fitted onto the outside of a window 22 and is attached thereto by swivel clips 24.

In FIG. 1, in this embodiment, the four sided unitary thermal solar screen-frame assembly 10 comprises a first pre-attached frame member 14 having two mitered ends and a second pre-attached frame member 16 having two mitered ends. The second pre-attached frame member 16 is essentially parallel to the first pre-attached frame member 14 in the assembled four sided unitary thermal solar screen-frame assembly 10. The four sided unitary thermal solar screen-frame assembly 10 further includes a first end member 18 having two mitered ends, in which each mitered end of the first end member 18 joins a mitered end of the first pre-attached frame member 14 and a mitered end of the second pre-attached frame member 16. In addition, the four sided unitary thermal solar screen-frame assembly 10 further includes a second end member 20 having two mitered ends, in which each mitered end of the second end member 20 joins an opposite mitered end of the first pre-attached frame member 14 and an opposite mitered end of the second pre-attached frame member 16. The first end member 18 is essentially parallel to the second end member 20 in the assembled four sided unitary thermal solar screen-frame assembly 10.

According to FIG. 2, which is a partial perspective view of a side corner of the four sided unitary thermal solar screen-frame assembly 10, the second pre-attached frame member 16 has a spline groove 30 for receiving a spline 26. Similarly, the end member 18 has a spline groove 30 for receiving a spline 26. A second closed end 54 of the thermal solar screen 12 is connected to the spline groove 30 of the second pre-attached frame member 16 by the spline 26. A portion of the spline 26 is loosely positioned near a first open end 50 of the thermal solar screen 12 and between each one of the mitered ends of the first and second pre-attached frame members 14 and 16. The first open end 50 of the thermal solar screen 12 is positioned for connecting to the spline groove 30 of the end member 18 by the spline 26, when the thermal solar screen is fully assembled. In this embodiment, the construction is similar at all four corners of the four sided unitary thermal solar screen-frame assembly 10.

Referring to FIG. 3, in a cross section through 3-3 of the second pre-attached frame member 16 of FIG. 2, the second pre-attached frame member 16 has a continuous and essentially rectangular shaped flat wall having a cavity 32, except in a wall of the second pre-attached frame member 16 that faces the window 22 (see FIG. 1). The wall of the second pre-attached frame member 16 has a spline groove 30. The spline groove 30 is essentially U-shaped and is located near an inner edge of the second pre-attached frame member 16 for receiving the second closed end 54 of the thermal solar screen 12 connected therein by the spline 26. The spline 26 is a flexible material that force fits the thermal solar screen 12 into the spline groove 30 to restrict movement of the thermal solar screen 12. In this embodiment, the construction is similar for all frame members of the entire four sided unitary thermal solar screen-frame assembly 10 of the thermal solar screen.

According to FIG. 4, which is a partial perspective view of an unassembled side corner of the thermal solar screen, a first leg 34 of an L-shaped corner insert 28 slides into a cavity 32 of the first pre-attached frame member 14. A second leg 36, of the corner insert 28, slides into the cavity 32 of the first end member 18. Each one of the legs, 34 and 36 of the corner insert 28, has an inclined extension 52 in the same plane and at each end of the corner insert 28 for coupling with each one of the cavities 32 of the first pre-attached frame member 14 and the first end member 18. In addition, each one of the legs, 34 and 36 of the corner insert 28, has a flange 38 at an inner edge perpendicular to and near the inclined extension 52 of each one of the corner inserts 28 for coupling with each one of the cavities 32 of the first pre-attached frame member 14 and the first end member 18. The combination of the inclined extension 52 and the flange 38 of each one of the corner inserts 28, insures each one of the corner inserts 28 can only slide into each one of the pre-attached frame members 14 and 16 and each one of the end members 18 and 20, so that the spline groove 30 remains continuous on the assembled four sided unitary thermal solar screen-frame assembly 10. In this embodiment, the construction is similar at all four corners of the four sided unitary thermal solar screen-frame assembly 10.

Referring to FIG. 5, the first pre-attached frame member 14 is connected to a first closed end 48 of the thermal solar screen 12, and the second pre-attached frame member 16 is additionally connected to the second closed end 54 of the thermal solar screen 12. In this embodiment, the thermal solar screen 12 is connected to each one of the first and second pre-attached frame members 14 and 16 by the spline 26. The spline 26 loops around each one of the mitered ends of the first and second pre-attached frame members 14 and 16 forming a pre-formed screen-frame assembly 40. A portion of the spline 26 is loosely positioned near the first open end 50 of the thermal solar screen 12 between each one of the mitered ends of the first and second pre-attached frame members 14 and 16. Each one of two corner inserts 28 are connected to each end of the first end member 18 to provide a first pre-formed end member 58. The first pre-formed end member 58, is inserted into the cavity 32 of each one of the mitered ends of each of the first and second pre-attached frame members 14 and 16, resulting in the spline 26 being loosely positioned near the spline groove 30 of the first end member 18. Similarly, a portion of the spline 26 is loosely positioned near a second open end 56 of the thermal solar screen 12 between each one of the opposite mitered ends of each one of the first and second pre-attached frame members 14 and 16. Each one of two corner inserts 28 are connected to each end of the second end member 20 to provide a second pre-formed end member 60. The second pre-formed end member 60, is inserted into each one of the cavities 32 of each one of the opposite mitered ends of each of the first and second pre-attached frame members 14 and 16, resulting in the spline 26 being loosely positioned near the spline groove 30 of the second end member 20.

In an alternative embodiment, the members 18 and 20 may be pre-attached to the thermal solar screen 12 in the form of a pre-formed screen assembly 40. In this case, the members 14 and 16 are connected to the corner inserts 28 at each end of the frame members 14 and 16 to form two pre-formed frame members that are connected to ends of the pre-attached frame members (now 18 and 20) of the pre-formed screen assembly 40. The remaining assembly is the same as discussed in the previous paragraph.

According to FIG. 6, the pre-formed screen-frame assembly 40 and end members 18 and 20 are partially inserted through an open end 46 of the container 42 having a closed end 44 to provide a kit. In this embodiment, the container 42 is a tube (FIG. 6). However, an alternative embodiment of the container 42 may be a box. The corner inserts 28 may also be placed within the container 42, either loosely or separately enclosed within a plurality of bags.

Alternatively, in a different embodiment, a first pre-formed end member 58 of the first end member 18 with the two corner inserts 28 joined to each end of the first end member 18 may replace the separate first end member 18 and two separate corner inserts 28. Similarly, a second pre-formed end member 60 of the second end member 20 with the two separate corner inserts 28 joined to each end of the second end member 20, may replace the separate second end member 20 and two corner inserts 28. Thus, the parts inserted into the container 42 are two pre-formed end members 58 and 60, and the pre-formed screen-frame assembly 40.

Several descriptions of a method for assembling the thermal solar screen follow.

In one embodiment, a kit comprising the pre-formed screen-frame assembly 40, four corner inserts 28 and the first and second end members 18 and 20 is unpacked from a container 42. The pre-formed screen-frame assembly 40 is unrolled to facilitate further assembly. Two corner inserts 28 are connected to each one of the mitered ends of the first end member 18 to make a first pre-formed end member 58. Similarly, two corner inserts 28 are connected to each one of the mitered ends of the second end member 20 to make a second pre-formed end member 60. The first pre-formed end member 58 is connected to each one of the mitered ends of the pre-formed screen-frame assembly 40 by sliding the corner inserts 28 that are part of the pre-formed end members 58 and 60 into each one of the cavities 32 of the first and second pre-attached frame members 14 and 16 at each one of the mitered ends of the pre-formed screen-frame assembly 40. Similarly, the second pre-formed end member 60 is connected to each one of the opposite mitered ends of the pre-formed screen-frame assembly 40. The loose spline 26 stretches between each one of the mitered ends of the pre-attached frame members 14 and 16, and is loosely positioned so that each one of the first and second open ends 50 and 56 of the thermal solar screen 12 is located between the spline 26 and the spline groove 30 of each one of the ends of the pre-formed end members 58 and 60. The thermal solar screen 12 is connected to each one of the pre-formed end members 58 and 60 by firmly pressing on the spline 26 forcing the first and second open ends 50, 56 of the thermal solar screen 12 into each one of the spline grooves 30 of each one of the pre-formed end members 58 and 60, completing the construction of the thermal solar screen.

In a second embodiment, a kit comprising the pre-formed screen-frame assembly 40 and two pre-formed end members 58 and 60 are unpacked from a container 42. The pre-formed screen-frame assembly 40 is unrolled to facilitate further assembly. The first pre-formed end member 58 is connected to each one of the mitered ends of the pre-formed screen-frame assembly 40 by sliding each one of the corner inserts 28 that are part of the pre-formed end members 58 and 60 into each one of the cavities 32 of each of the first and second pre-attached frame members 14 and 16 at each one of the mitered ends of the pre-formed screen-frame assembly 40. Similarly, the second pre-formed end member 60 is connected to each one of the opposite mitered ends of the pre-formed screen-frame assembly 40. The loose spline 26 stretches between each one of the mitered ends of each one of the pre-attached frame members 14 and 16, and is loosely positioned so that each one of the first and second open ends 50 and 56 of the thermal solar screen 12 is located between the spline 26 and the spline groove 30 of each end of the pre-formed end members 58 and 60. The thermal solar screen 12 is connected to each one of the pre-formed end members 58 and 60 by firmly pressing on the spline 26 forcing the first and second open ends 50, 56 of thermal solar screen 12 into each one of the spline grooves 30 of each one of the pre-formed end members 58 and 60, completing the construction of the thermal solar screen. This second embodiment saves additional steps of assembly to make the pre-formed end members 58 and 60, eliminating potential assembly errors and improving construction efficiency.

In summary, the present invention is directed to a thermal solar screen kit and methods of assembly of solar thermal screens. The kit comprises a pre-formed screen-frame assembly, in which a thermal solar screen is anchored between two essentially parallel pre-attached frame members; two end frame members and four corner inserts, packed within a container. Alternatively, the kit comprises a pre-formed screen-frame assembly and two pre-formed end members packed within a container. Methods for assembling the thermal solar screen using different embodiments were disclosed.

While the invention has been particularly shown and described with reference to preferred embodiments thereof, it will be understood by those skilled in the art that the foregoing and other changes in form and details may be made therein without departing from the spirit and scope of the invention.

For example, the thermal solar screen kit can be altered in various ways within the basic concept of this invention. In particular, it is possible to use frame members that have straight cut ends rather than mitered ends. The lengths of frame members may be custom fit to accommodate various window sizes. Thermal solar screen kits can be custom fit to accommodate other openings, such as patios. Different thermal solar screen materials can be custom ordered and inserted into the pre-formed screen-frame assembly providing flexibility for consumers. The term thermal solar thermal screen as used in this application and in the claims is intended to cover solar screens, sun screens and shade screens.

1. A kit for assembling a thermal solar screen-frame assembly comprising, in combination:
a container;
a preformed screen-frame assembly located in said container and comprising a thermal solar screen and two pre-attached frame members, said thermal solar screen being attached at each one of two opposite ends thereof to one of said two pre-attached frame members located in said container;
a pair of other frame members located in said container; and
means located in said container for connecting said preformed screen-frame assembly to said pair of other frame members to form a four frame sided unitary thermal solar screen-frame assembly after removing at least said pre-formed screen frame assembly from said container and coupling said connecting means to both said pre-formed screen-frame assembly and said pair of other frame members.

2. The kit for assembling a thermal solar screen-frame assembly according to claim 1 including each one of said frame members having two ends, a plurality of corner inserts located in said container for connecting to said two ends of said pair of other frame members to said pre-formed screen-frame assembly.

3. The kit for assembling a thermal solar screen-frame assembly according to claim 1 wherein said thermal solar screen is connected to each frame member of said four tame sided unitary thermal screen-frame assembly by a spline.

4. A kit for assembling a thermal solar screen-frame assembly comprising, in combination:
a container
a pre formed screen-frame assembly located in said container and comprising a thermal solar screen and two pre-attached frame members; and
a pair of preformed frame members located in said container for coupling to said two pre-attached frame members to form a four frame sided unitary thermal solar screen-frame assembly after removing at least said pre-formed screen-frame assembly from said container and coupling said pre-formed screen-frame assembly to said pair of preformed frame members.

5. The kit for assembling a thermal solar screen-frame assembly according to claim 4 wherein each one of said pair of pre-formed frame members comprises a frame member having two ends and a pair of connecting corner inserts, each one of said pair of corner inserts connected to one of the two ends of said frame member.

6. The kit for assembling a thermal solar screen-frame assembly according to claim 5 wherein each one of said pair of connecting corner inserts also connected to one end of one of said pre-attached frame members to form a four frame sided unitary thermal solar screen-frame assembly after removing at least said pre-formed screen-frame assembly from said container and coupling said preformed screen-frame assembly to said pair of pre-formed frame members.

7. The kit for assembling a thermal solar screen-frame assembly according to claim 4 wherein said thermal solar screen is connected to each frame member of said four frame sided unitary thermal screen-frame assembly by a spline.

8. A method for assembling a thermal solar screen-frame assembly comprising the steps of:
providing a container:
providing a pre-formed screen-frame assembly located in said container and comprising a thermal solar screen and two pre-attached frame members, said thermal solar screen being attached at one of two opposite ends thereof to one of said two pre-attached fame members located in said container;
providing a pair of other frame members located in said container; and
providing means located in said container for connecting said preformed screen-frame assembly to said pair of other frame members to form a four frame sided unitary thermal solar screen-frame assembly after removing at least said pre-formed screen-frame assembly from said container and coupling said connecting means to both said preformed screen-frame assembly and said pair of other frame members.

9. The method for assembling a thermal solar screen-frame assembly according to claim 8 including the steps of:
providing a plurality of corner inserts;
removing at least said pre-formed screen-frame assembly from said container;
providing each one of said pair of frame members having two ends; and
coupling each one of said plurality of corner inserts to both said formed screen-frame assembly and said ends of said pair of other frame members.

10. The method for assembling a thermal solar screen-frame assembly according to claim 8 further comprising the step of: connecting said thermal solar screen to each frame member of said four frame sided unitary thermal screen-frame assembly by a spline.

11. A method for assembling a thermal solar screen-frame assembly comprising the steps of
providing a container:
providing a pre-formed screen-frame assembly located in said container and comprising a thermal solar screen and two pre-attached frame members; and
providing a pair of pre-formed frame members located in said container for coupling to said two pre-attached frame members to form a four frame sided unitary thermal solar screen-frame assembly a removing at least said pre-formed screen-frame assembly from said container and coupling said preformed screen-frame assembly to said pair of preformed frame members.

12. The method for assembling a thermal solar screen-frame assembly according to claim 11 including the step of providing each one of said pair of pre formed frame members comprises a frame member having two ends and a pair of connecting corner inserts, each one of said pair of corner inserts connected to one of the two ends of said frame member.

13. The method for assembling a thermal solar screen-frame assembly according to claim 12 further including the steps of:
removing at least said pre-formed screen-frame assembly from said container;
connecting each one of said pair of connecting corner inserts to one end of one of said pre-attached frame members; and
coupling said preformed screen-frame assembly to said pair of pre-formed frame members to form a four frame sided unitary thermal solar screen-frame assembly.

14. The method for assembling a thermal solar screen-frame assembly according to claim 11 further comprising the step of: connecting said thermal solar screen to each frame member of said four frame sided unitary thermal screen-frame assembly by a spline.
